(19) United States
(12) Patent Application Publication
(10) Pub. No.: US 2025/0196676 A1
(43) Pub. Date: Jun. 19, 2025

(54) ON-BOARD CHARGER CONTROL METHOD AND APPARATUS FOR MULTIPLE POWER SUPPLIES

(71) Applicants: Hyundai Motor Company, Seoul (KR); Kia Corporation, Seoul (KR)

(72) Inventors: Sang Youn Lee, Icheon-si (KR); Jae Hyun Kim, Osan-si (KR); Gyu Tae Choi, Suwon-si (KR); Sung Uk Park, Busan (KR)

(21) Appl. No.: 18/655,861

(22) Filed: May 6, 2024

(30) Foreign Application Priority Data
Dec. 19, 2023 (KR) 10-2023-0185949

(51) Int. Cl. B60L 53/22; H02M 1/00; H02M 1/08; H02M 3/335

(52) U.S. Cl. CPC B60L 53/22; H02M 1/0009; H02M 1/083; H02M 3/33584; B60L 2210/10

(57) ABSTRACT

An embodiment control method for a bidirectional on-board charger (OBC) includes measuring a first voltage of a first alternating current (AC) port connected to a first line among three-phase AC input lines and measuring a second voltage of a second AC port connected to a second line among the three-phase AC input lines and controlling a low-frequency leg among a plurality of legs in the bidirectional OBC to be synchronized to the first AC port or the second AC port based on phase angles of the first voltage and the second voltage.

### CROSS-REFERENCE TO RELATED APPLICATIONS

This application claims the benefit of Korean Patent Application No. 10-2023-0185949, filed on Dec. 19, 2023, which application is hereby incorporated herein by reference.

### TECHNICAL FIELD

The present disclosure relates to an on-board charger (OBC) control method and apparatus for multiple power supplies.

### BACKGROUND

In general, an electric vehicle obtains the driving energy of an electric motor from a high-voltage battery and needs to be recharged via a bidirectional electric vehicle service equipment (EVSE) when the state of charge (SOC) of such a high-voltage battery becomes lower than a threshold.

The high-voltage battery provided in such an electric vehicle can operate as an energy storage system (ESS), and accordingly, the electric vehicle can mount a vehicle-to-grid (V2G) mode that supplies the power of the high-voltage battery to the power grid (system power) and a vehicle-to-load (V2L) mode that supplies the power of the high-voltage battery to various electronic devices (e.g., household electronics). In this case, household electronics may include a laptop, a fan, a refrigerator, a washing machine, a TV, an electric heater, an electric rice cooker, a microwave, etc.

An electric vehicle should have a bidirectional OBC to operate in a charging mode, a V2G mode, or a V2L mode. As an example of such a bidirectional OBC, Korean Patent Application Publication No. 10-2023-0015763 (Publication Date: Jan. 31, 2023) titled “Apparatus For Controlling Bi-Directional On-Board Charger Of Electric Vehicle And Method Thereof” discloses a method of forming an AC voltage having the same period and phase but different root mean square (RMS) values at two ports of a bidirectional OBC. By utilizing this, it is possible to construct a system that supplies electric power to multiple electronic devices by increasing the output of a single bidirectional OBC.

In this technology, however, the two ports have no choice but to have the same period and phase, and when different loads, especially inductive loads and capacitive loads, are connected to each port, the phase difference of electric current becomes significantly larger compared to the voltage formed by the OBC. In this case, there is a problem in that electric current distortion occurs near the zero voltage of the V_{ac} phase voltage.

Therefore, in this field of technology, there is a need for an OBC control technology that minimizes the electric current distortion caused by the phase difference of each phase when using two different alternating current (AC) input ports of a bidirectional OBC.

### SUMMARY

The present disclosure relates to an OBC control method and apparatus for multiple power supplies. Particular embodiments relate to an OBC control method and apparatus for multiple power supplies, which minimize electric current distortion caused by a phase difference of a load when operating a V2L function.

An embodiment of the present disclosure provides an OBC control technology that minimizes electric current distortion caused by the position difference of each phase when using two different AC input ports of a bidirectional OBC.

A control method for a bidirectional OBC of an eco-friendly vehicle according to an exemplary embodiment of the present disclosure may include a step of measuring a first voltage of a first AC port connected to a first line among three-phase AC input lines and measuring a second voltage of a second AC port connected to a second line among the three-phase AC input lines, and a step of controlling a low-frequency leg among a plurality of legs provided in the bidirectional OBC to be synchronized to the first AC port or the second AC port on the basis of phase angles of the first and second voltages.

In this case, the bidirectional OBC may be provided with a three-phase bidirectional power factor corrector (PFC), wherein a first switch and a fourth switch form a first leg, a second switch and a fifth switch form a second leg, a third switch and a sixth switch form a third leg, the first line is connected to the first leg, the second line is connected to the second leg, a third line different from the first line and the second line is connected to the third leg, and the low-frequency leg may be the third leg.

In this case, the switches of the third leg may be controlled to be synchronized to the switches of the first leg or the second leg on the basis of the phase angles of the first and second voltages.

In this case, the switches of the third leg may be controlled to be synchronized to the switches of the first leg when the phase angle of the first voltage is faster than the phase angle of the second voltage.

In this case, the switches of the third leg may be controlled to be synchronized to the switches of the second leg when the phase angle of the second voltage is faster than the phase angle of the first voltage.

In this case, the control method of controlling the bidirectional OBC may further include a step of generating a first control signal to control the switches of the first leg and a second control signal to control the switches of the second leg.

In this case, the control method of controlling the bidirectional OBC may further include a step of generating a third control signal to control the switches of the third leg on the basis of the phase angles of the first and second voltages.

In this case, the control method of controlling the bidirectional OBC may further include a step of generating first to third pulse width modulation (PWM) signals by modulating pulse widths of the first to third control signals and a step of controlling the switches of the first to third legs on the basis of the first to third PWM signals.

Meanwhile, a control apparatus for a bidirectional OBC of an eco-friendly vehicle according to an exemplary embodiment of the present disclosure may include a sensor portion that measures a first voltage by using a voltage sensor connected to the electronic device connected to a first line among three-phase AC input lines and measures a second voltage by using a voltage sensor connected to an electronic device connected to a second line among the three-phase AC input lines, and a controller that controls a low-frequency leg among a plurality of legs provided in a bidirectional OBC to be synchronized to the first AC port or the second AC port on the basis of phase angles of the first and second voltages.

In this case, the bidirectional OBC may include a three-phase bidirectional PFC, wherein a first switch and a fourth switch form a first leg, a second switch and a fifth switch form a second leg, a third switch and a sixth switch form a third leg, the first line is connected to the first leg, the second line is connected to the second leg, a third line different from the first line and the second line is connected to the third leg, and the low-frequency leg may be the third leg.

In this case, the switches of the third leg may be controlled to be synchronized to the switches of the first leg or the second leg on the basis of the phase angles of the first and second voltages.

In this case, the switches of the third leg may be controlled to be synchronized to the switches of the first leg when the phase angle of the first voltage is faster than the phase angle of the second voltage.

In this case, the switches of the third leg may be controlled to be synchronized to the switches of the second leg when the phase angle of the second voltage is faster than the phase angle of the first voltage.

In this case, the controller may generate a first control signal to control the switches of the first leg and a second control signal to control the switches of the second leg.

In this case, the controller may generate a third control signal to control the switches of the third leg on the basis of the phase angles of the first and second voltages.

In this case, the controller may generate first to third PWM signals by modulating the pulse widths of the first to third control signals and may control the switches of the first to third legs on the basis of the first to third PWM signals.

According to embodiments of the present disclosure, the electric current distortion caused by a phase difference of each phase may be minimized when using two different AC input ports of the bidirectional OBC.

In addition, the electric current distortion caused by the phase difference of the load in a dual V2L operation may be minimized, so that a stable power source is served and the power stability is increased.

In addition, consumers may connect electrical devices to AC input ports without distinguishing between capacitive and inductive loads, thereby increasing convenience.

In addition, there is no need to add additional elements in order to reduce the electric current distortion caused by the phase difference of loads, thereby reducing costs.

### BRIEF DESCRIPTION OF THE DRAWINGS

The above and other objectives, features, and other advantages of embodiments of the present disclosure will be more clearly understood from the following detailed description when taken in conjunction with the accompanying drawings.

FIG. 1 is a block diagram illustrating a schematic configuration of a bidirectional on-board charger (OBC) control apparatus for an eco-friendly vehicle according to an exemplary embodiment of the present disclosure.

FIG. 2 is a circuit diagram of a bidirectional OBC control apparatus for an eco-friendly vehicle according to the exemplary embodiment of FIG. 1.

FIG. 3 is a view showing an example of the operations of a controller provided in a bidirectional OBC control apparatus of an eco-friendly vehicle according to the exemplary embodiment of FIG. 1.

FIGS. 4A to 4D are control diagrams specifying a step of generating a leading current signal during the operations of a controller of FIG. 3.

FIGS. 5A and 5B are views showing an example of a graph comparing the difference in electric current distortion before and after applying a bidirectional OBC control apparatus of an eco-friendly vehicle according to an exemplary embodiment of the present disclosure.

FIG. 6 shows a bidirectional OBC control method of an eco-friendly vehicle according to an exemplary embodiment of the present disclosure.

### DETAILED DESCRIPTION OF ILLUSTRATIVE EMBODIMENTS

Hereinafter, exemplary embodiments disclosed in this specification will be described in detail with reference to the accompanying drawings, the same or similar components will be assigned with the same reference number, and duplicate descriptions thereof will be omitted. The suffix “module” and “portion” of the components used in the following description are given or used only in consideration of the ease of preparing the specification, and they do not have meanings or roles that are distinguished from each other. In addition, when it is determined that the detailed description of the related known technology in describing the exemplary embodiments disclosed in this specification may obscure the gist of the exemplary embodiments disclosed in this specification, the detailed description will be omitted. In addition, the accompanying drawings are only intended to facilitate understanding of the exemplary embodiments disclosed in this specification, and the technical ideas disclosed in this specification are not limited by the accompanying drawings and should be understood as including all changes, equivalents, or substitutes included in the spirit and technical scope of the present disclosure.

Terms including ordinal numbers, such as a first and a second, may be used to describe various components, but the components are not limited by the terms. The terms are used only for the purpose of distinguishing one component from another.

When it is stated that a component is “connected” or “linked” to another component, it should be understood that it may be directly connected or connected to that other component, but that another component may exist in the middle. On the other hand, when it is stated that one component is “directly connected” or “directly linked” to another component, it should be understood that no other component exists in the middle.

Singular expressions include plural expressions unless the context clearly indicates otherwise.

In this specification, terms such as “include” or “have” are intended to specify the existence of features, numbers, steps, actions, components, parts, or combinations thereof described in the specification, and they should be understood not to preclude the existence or addition of one or more other features, numbers, steps, actions, components, parts, or combinations thereof.

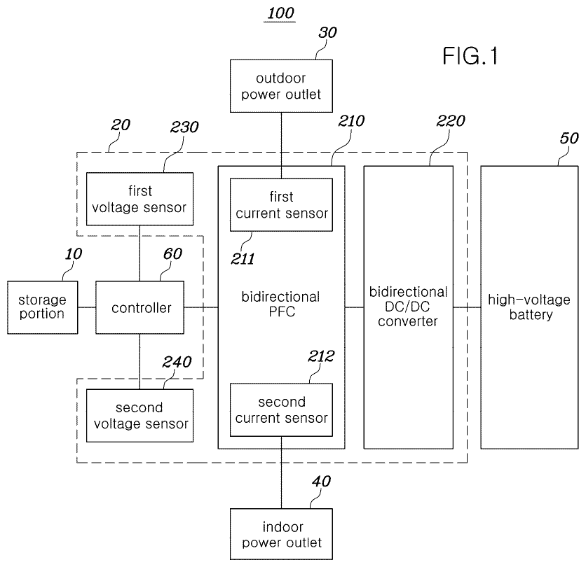

FIG. 1 is a block diagram illustrating a schematic configuration of a bidirectional on-board charger (OBC) control apparatus 100 for an eco-friendly vehicle according to an exemplary embodiment of the present disclosure.

Referring to FIG. 1, the bidirectional OBC control apparatus for an eco-friendly vehicle according to the present exemplary embodiment may include a storage portion 10, a bidirectional OBC 20, an outdoor power outlet 30, an indoor power outlet 40, a high-voltage battery 50, and a controller 60.

In this case, each component may be combined with each other to be implemented as one body, or some components may be omitted depending on the method of implementing the bidirectional OBC control apparatus according to the present exemplary embodiment.

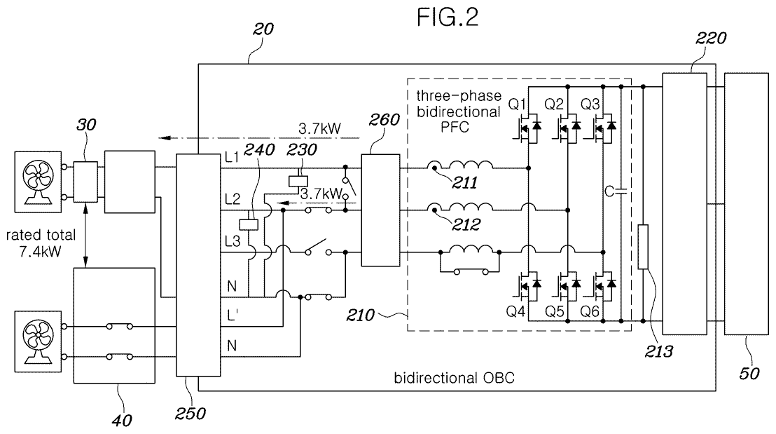

FIG. 2 is a circuit diagram of the bidirectional OBC control apparatus 100 for an eco-friendly vehicle according to the exemplary embodiment of FIG. 1.

Hereinafter, components of the bidirectional OBC control apparatus of an eco-friendly vehicle according to an exemplary embodiment of the present disclosure will be described in detail with reference to FIGS. 1 and 2.

The storage portion 10 may store various logic, algorithms, and programs required in the process of measuring the demand current of electronic devices connected to the outdoor power outlet and the indoor power outlet among the three-phase AC input lines and controlling the bidirectional OBC on the basis of the demand current.

The storage portion 10 may store a reference link voltage (V_{link,ref}), a reference voltage (V_{ac,dq,ref}) of a dq-converted outdoor power outlet 30, a reference voltage (V_{ac,dq,ref}) of a dq-transformed indoor power outlet 40, a reference frequency (f_{ac1,ref}) of the AC voltage supplied to the outdoor power outlet 30, and a reference frequency (f_{ac2,ref}) of the AC voltage supplied to the indoor power outlet 40.

Herein, the dq transformation may mean transforming a three phase into a two phase, wherein one of the three phase is aligned with the x-axis (a reference axis) and the rest are transformed into two phase on the basis of the axis aligned with the x-axis. When the three phase is converted into the two phase through the dq transformation as described above, it is possible to control within a two-dimensional orthogonal coordinate that we are familiar with, making it easier to control.

The storage portion 10 may include at least one type of storage medium among a type of memory such as flash memory type, hard disk type, micro type, and card type—SD card (secure digital card) or XD card (eXtream digital card)—and a type of memory such as random access memory (RAM), static RAM (SRAM), read-only memory (ROM), programmable ROM (PROM), electrically erasable ROM (EEPROM), magnetic memory (MRAM), magnetic disk, and an optical disk.

The bidirectional OBC 20 may not only charge the high-voltage battery 50 by converting alternating current into direct current, but it may also supply the electric power to a power network system (or bidirectional EVSE) by converting the DC power of the high-voltage battery 50 into the AC power (the same voltage and frequency as commercial power).

The bidirectional OBC 20 may include a three-phase bidirectional PFC 210, a bidirectional DC/DC converter 220, a first voltage sensor 230, a second voltage sensor 240, an AC high-voltage connector 250, and an input filter 260. Herein, the three-phase bidirectional PFC 210 may be a module to increase energy efficiency and may include a first current sensor 211 to measure an inductor current of an L1 line, a second current sensor 212 to measure an inductor current of an L2 line, and a third voltage sensor 213 to measure a link voltage. At this time, the three-phase bidirectional PFC 210 may perform AC/DC power conversion, power factor correction, and reactive power minimization. The bidirectional DC/DC converter 220 may stably supply the power of the high-voltage battery 50 to the power network system, the outdoor power outlet 30, or the indoor power outlet 40, or it may stably supply the power supplied from an electric vehicle service equipment (EVSE) to the high-voltage battery 50. The first voltage sensor 230 may measure a voltage of the single-phase AC charging L1 line during the single-phase charging. The second voltage sensor 240 may measure a voltage of the L2 line or a voltage of the L3 line among the three-phase AC input lines. The AC high-voltage connector 250 may connect the vehicle charging port and the indoor power outlet 40 to the bidirectional OBC 20. The input filter 260 may remove the noise of AC power supplied from the EVSE. N line may refer to an N-phase (Neutral conductor) line.

The outdoor power outlet 30 may be a module that is detachably attached to the charging port of the electric vehicle, and it may be connected to electronic devices to transmit the electric power when the high-voltage battery 50 is not being charged.

The indoor power outlet 40 may be located inside the electric vehicle, and it may transmit the power of the high-voltage battery 50 to the connected electronic devices. In this case, the line L′ that supplies electric power to the indoor power outlet 40 may be branched from the L2 line or the L3 line.

Meanwhile, the controller 60 may perform overall control to ensure that each of the above components performs its own functions properly. Such a controller 60 may be implemented in the form of hardware, in the form of software, or in the form of a combination of hardware and software. Preferably, the controller 60 may be implemented as a microprocessor, but it is not limited thereto.

In particular, the controller 60 may measure a first voltage that is a voltage of an electronic device connected to the first line L1 among the three-phase AC input lines L1, L2, and L3 and a second voltage that is a voltage of an electronic device connected to the second line L2 among the three-phase AC input lines L1, L2, and L3, and the controller 60 may perform various controls in the process of controlling the bidirectional OBC on the basis of the first and second voltages.

In this case, the controller 60 may control the bidirectional OBC on the basis of the phase angles of the first and second voltages.

Meanwhile, as shown in FIG. 2, the power to be supplied to the electronic device connected to the outdoor power outlet 30 may pass through the input filter 260 via the line L1, and the power to be supplied to the electronic device connected to the indoor power outlet 40 may pass through the input filter 260 via the line L2. At this time, the controller 60 may open a switch connecting the line L1 and the line L2 and may close a switch located on the line L2 between the AC high-voltage connector 250 and the input filter 260.

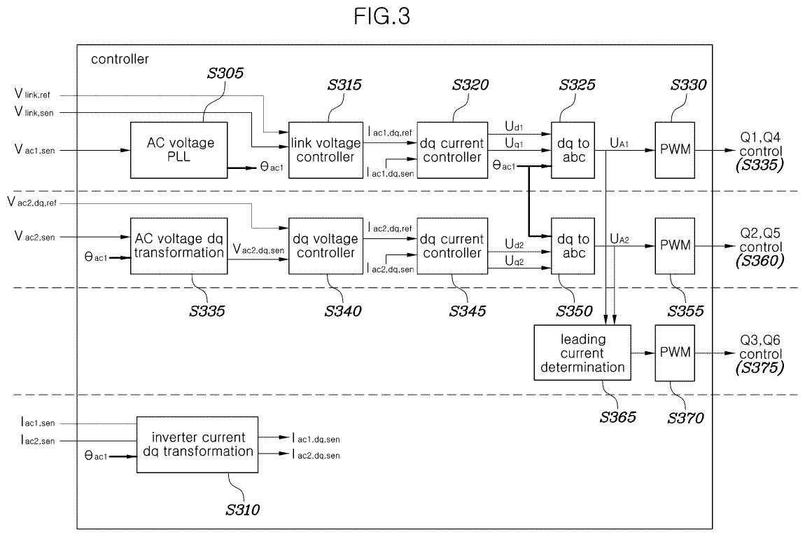

In order to supply electric power to the electronic device connected to the outdoor power outlet 30 as well as the electronic device connected to the indoor power outlet 40, the controller 60 may perform operations as shown in FIG. 3 below.

The controller 60 may control the specific switches Q1 and Q4 of the three-phase bidirectional PFC 210 in order to supply the electric power to the electronic device connected to the outdoor power outlet 30 and control the specific switches Q2 and Q5 of the three-phase bidirectional PFC 210 in order to supply the electric power to the electronic device connected to the indoor power outlet 40. Meanwhile, the switches Q3 and Q6 may be used to determine the leading current.

FIG. 3 shows an example of the operations of a controller provided in the bidirectional OBC control apparatus of an eco-friendly vehicle according to the exemplary embodiment of FIG. 1.

Referring to FIG. 3, the controller 60 may first extract a phase (θ_{ac1}) from the L1 voltage (V_{ac1,Sen}) measured by the first voltage sensor 230 on the basis of a phase-locked loop (PLL) in order to supply the electric power to the electronic device connected to the outdoor power outlet 30 (S305).

In addition, the controller 60 may perform the dq transformation on both the inductor current (I_{ac1,sen}) measured by the first current sensor 211 and the inductor current (I_{ac2,sen}) measured by the second current sensor 212 in order to be synchronized with the phase (θ_{ac1}) (S310).

At this time, in this specification, the dq-transformed current of the inductor current (I_{ac2,sen}) is defined as a first current (I_{ac1,dq,sen}), and the dq-transformed current of the inductor current (I_{ac2,sen}) is defined as the second current (I_{ac2,dq,sen}).

In addition, the controller 60 may determine a first reference current (I_{ac1,dq,ref}) that causes the link voltage (V_{link,sen}) measured in the third voltage sensor 213 to follow the reference voltage (V_{link,ref}) with respect to the link voltage (S315). In this case, the first reference current is a dq-transformed reference current.

In addition, the controller 60 may generate a d-axis first current control signal (U_{d1}) and a q-axis first current control signal (U_{q1}) that cause the first currents (I_{ac1,dq,sen}) to follow the first reference currents (I_{ac1,dq,ref}) (S320).

In addition, the controller 60 may perform the DQ to ABC transformation on the d-axis first current control signal (U_{d1}) and the q-axis first current control signal (U_{q1}) on the basis of the phase (θ_{ac1}), thereby generating a first control signal (U_{A1}) (S325).

In addition, the controller 60 may generate a first PWM signal by performing the PWM on the first control signal (U_{A1}) S330 and may control the switches Q1 and Q4 of the three-phase bidirectional PFC 210 on the basis of the first PWM signal (S335).

Meanwhile, in an effort to supply electric power to the electronic device connected to the indoor power outlet 40, the controller 60 may perform the DQ transformation on the L2 voltage (V_{ac2,sen}) measured by the second voltage sensor 240 in order to be in synchronization with the phase (θ_{ac1}) (S340). In this case, the dq-transformed L2 voltage (V_{ac2,sen}) may be referred to as a second voltage (V_{ac2,dq,sen}).

In addition, the controller 60 may determine a second reference current (I_{ac2,dq,ref}) that causes the second voltage (V_{ac2,dq,sen}) to follow the reference voltages (V_{ac2,dq,ref}) of the dq-transformed indoor power outlet 40 stored in the storage portion 10 (S340). In this case, the second reference current may be the dq-transformed reference current.

In addition, the controller 60 may determine a d-axis second current control signal (U_{d2}) and a q-axis second current control signal (U_{q2}) that cause the dq-transformed second current (I_{ac2,dq,sen}) of the inductor current (I_{ac2,sen}) measured by the second current sensor 212 to follow the second reference current (I_{ac2,dq,ref}) (S345).

In addition, the controller 60 may perform the DQ to ABC transformation on the d-axis second current control signal (U_{d2}) and the q-axis second current control signal (U_{q2}) in a state to be synchronized with the phase (θ_{ac1}), thereby generating a second control signal (U_{A2}) (S350).

In addition, the controller 60 may generate a second PWM signal by performing a PWM on the second control signal (U_{A2}) S355 and may control the switches Q2 and Q5 of the three-phase bidirectional PFC 210 on the basis of the second PWM signal (S360).

Meanwhile, the controller 60 may generate a leading current determination signal on the basis of the first control signal (U_{A1}) generated in step S325 as well as the second control signal (U_{A2}) generated in step S350 (S365) and perform the PWM on the leading current determination signal, thereby generating a third PWM signal S370 and controlling the switches Q3 and Q6 of the three-phase bidirectional PFC 210 on the basis of the third PWM signal (S375).

At this time, the leading current determination signal may be a signal generated by selecting a control signal corresponding to a port with a faster phase among the first control signal (U_{A1}) or the second control signal (U_{A2}).

In this case, the third PWM signal to control the switches Q3 and Q6 may be a signal to be synchronized to the first PWM signal to control the switches Q1 and Q4 when the phase (θ_{ac1}) of the L1 voltage (V_{ac1,sen}) is faster than the phase (θ_{ac2}) of the L2 voltage (V_{ac2,sen}).

On the contrary, the third PWM signal to control the switches Q3 and Q6 may be a signal to be synchronized to the second PWM signal to control the switches Q2 and Q5 when the phase (θ_{ac2}) of the L2 voltage (V_{ac2,sen}) is faster than the phase (θ_{ac1}) of the L1 voltage (V_{ac1,sen}).

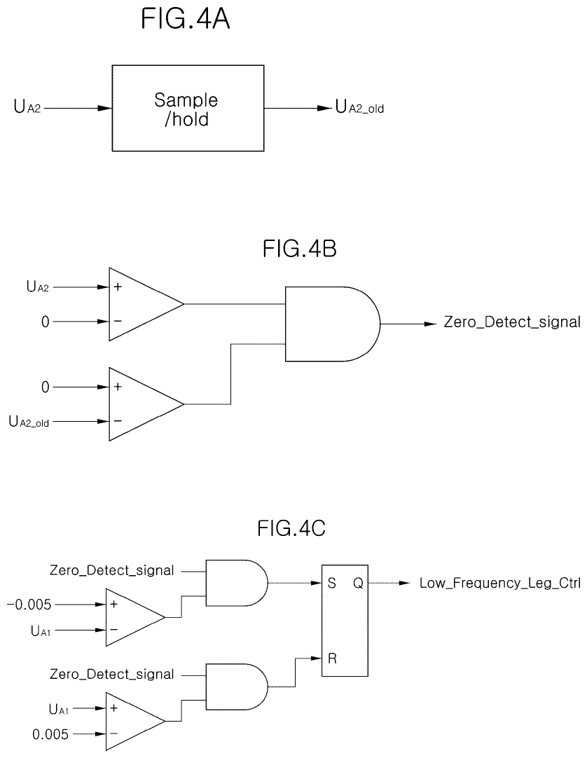

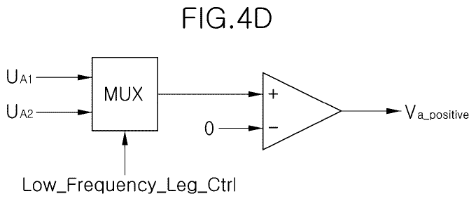

FIGS. 4A to 4D are control diagrams specifying a step of generating a leading current signal during operations of the controller of FIG. 3.

First, referring to FIG. 4A, the controller 60 may generate a sample and hold signal (U_{A2} old) by passing the second control signal (U_{A2}) through a sample and hold circuit.

In this case, the sample and hold circuit may be a circuit that holds the input signal for a certain period of time, so that the sample and hold signal (U_{A2} old) may have the same value as the second control signal (U_{A2}) at any time in the past.

In addition, referring to FIG. 4B, the controller 60 may input the second control signal (U_{A2}) into the (+) terminal of a comparator circuit and input the value of ‘0’ into the (−) terminal of the comparator circuit, thereby outputting a first comparison signal.

In addition, the controller 60 may input the value of ‘0’ into the (+) terminal of the comparator circuit and input the sample and hold signal (U_{A2_old}) into the (−) terminal of the comparator circuit, thereby outputting a second comparison signal.

In addition, the controller 60 may input the first comparison signal and the second comparison signal into an AND gate and output a zero detection signal (Zero_Detect_signal) as an output signal.

In this case, the zero detection signal (Zero_Detect_signal) may have a value of ‘0’ when at least one of the second control signal (U_{A2}) and the sample and hold signal (U_{A2_old}) has a value of ‘0’ and may output a non-zero value only when both have a value other than ‘0’.

Thus, the zero detection signal (Zero_Detect_signal) may detect a zero voltage rising section of the L2 voltage.

In addition, referring to FIG. 4C, the controller 60 may input a first threshold value into the (+) terminal of the comparator circuit and input the first control signal (U_{A1}) into the (−) terminal of the comparator circuit, thereby outputting a third comparison signal.

In this case, the first threshold value may have various negative values and, for example, may have a value of ‘−0.005’ as shown in FIG. 4C.

In this case, the controller 60 may input the zero detection signal (Zero_Detect_signal) and the third comparison signal into the AND gate and then input the output signal to the S input terminal of the RS flip-flop.

In addition, the controller 60 may input the first control signal (U_{A1}) into the (+) terminal of the comparator circuit and input a second threshold value into the (−) terminal of the comparator circuit, thereby outputting a fourth comparison signal.

In this case, the second threshold value may have various positive values and, for example, may have a value of ‘0.005’ as shown in FIG. 4C.

In this case, the controller 60 may input the zero detection signal (Zero_Detect_signal) and the fourth comparison signal into the AND gate and then input the output signal into the R input terminal of the RS flip-flop.

In addition, the controller 60 may output a low-frequency leg control signal (Low_Frequency_Leg_Ctrl) which is an output signal of the Q output terminal of the RS Flip Flop.

In this case, the low-frequency leg control signal (Low_Frequency_Leg_Ctrl) may be set when the first comparison signal is less than the first threshold value at the moment when the zero detection signal (Zero_Detect_signal) occurs.

Meanwhile, the low-frequency leg control signal (Low_Frequency_Leg_Ctrl) may be reset when the first comparison signal is greater than the second threshold value at the moment when the zero detection signal (Zero_Detect_signal) occurs.

That is, the low-frequency leg control signal (Low_Frequency_Leg_Ctrl) may have a value of ‘0’ when the phase of the L1 voltage (V_{ac1,sen}) is faster than the phase of the L2 voltage (V_{ac2,sen}), and the low-frequency leg control signal (Low_Frequency_Leg_Ctrl) may have a value of ‘1’ when the phase of the L2 voltage (V_{ac2,sen}) is faster than the phase of the L1 voltage (V_{ac1,sen}).

In addition, referring to FIG. 4D, the controller 60 may use the first control signal and the second control signal as input signals of a 2 TO 1 multiplexer and may use the low-frequency leg control signal (Low_Frequency_Leg_Ctrl) as a selection signal, thereby outputting a leading current determination control signal (V_{a_positive}) as an output signal.

In this case, the leading current determination control signal (V_{a_positive}) may output the value of the first control signal (U_{A1}) when the low-frequency leg control signal (Low_Frequency_Leg_Ctrl) has a value of ‘0’ and the leading current determination control signal (V_{a_positive}) may output the value of the second control signal (U_{A2}) when the low-frequency leg control signal (Low_Frequency_Leg_Ctrl) has a value of ‘1’.

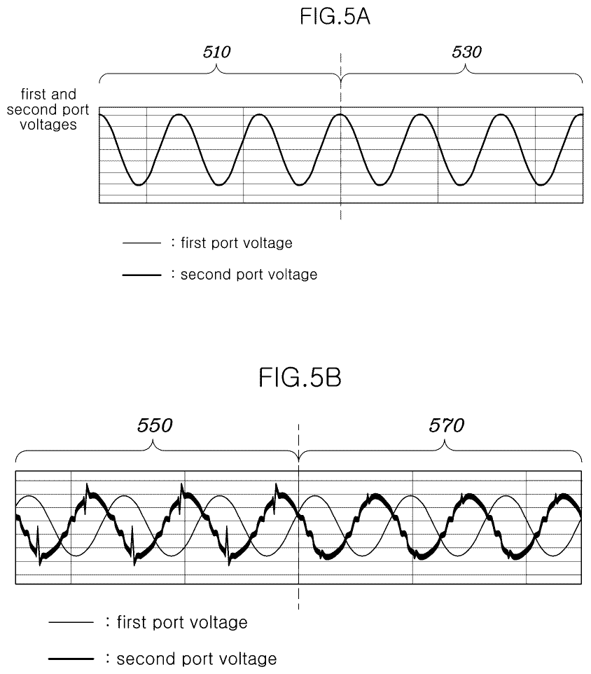

FIGS. 5A and 5B show an example of a graph comparing the difference in the electric current distortion before and after applying the bidirectional OBC control apparatus of an eco-friendly vehicle according to an exemplary embodiment of the present disclosure.

In the examples of FIGS. 5A and 5B, the vehicle may perform a dual V2L control that outputs a voltage of 220V.

At this time, two V2L voltage ports may be connected to the vehicle, wherein the first port is connected to an inductive load having an apparent current of 16 A and a phase of 60 degrees and the second port is connected to a capacitive load having an apparent current of 16 A and a phase of −60 degrees.

FIG. 5A is a graph showing the change in electric voltages measured by the voltage sensors connected to the loads of the first port and the second port, and FIG. 5B is a graph showing the change in the electric currents derived from currents measured by the current sensors connected to the loads of the first port and the second port.

The period 510 may show the change in voltage of the loads connected to the first port and the second port in a conventional vehicle to which the leading current determination control of embodiments of the present disclosure is not applied and the period 530 may show the change in voltage of the loads connected to the first port and the second port in the vehicle to which the leading current determination control of embodiments of the present disclosure is applied.

Referring to FIG. 5A, it may be seen that the voltage of the load connected to the first port and the voltage of the load connected to the second port almost coincide with each other as one graph.

In addition, in FIG. 5B, the period 550 may show the change in the electric current of the loads connected to the first port and the second port in a conventional vehicle to which the leading current determination control of embodiments of the present disclosure is not applied, and the period 570 may show the change in the electric current of the loads connected to the first port and the second port in the vehicle to which the leading current determination control of embodiments of the present disclosure is applied.

Referring to FIG. 5B, the current distortion of the load connected to the second port of the vehicle to which the leading current determination control of embodiments of the present disclosure is applied may be significantly improved compared to the load connected to the second port of the conventional vehicle.

Meanwhile, Table 1 below may compare the distortion (total harmonic distortion, THD) of the first and second ports in a conventional vehicle that do not perform the leading current determination control according to an exemplary embodiment of the present disclosure and the distortion of the first and second ports in a vehicle that performs the leading current determination control according to an exemplary embodiment of the present disclosure.

TABLE 1

| | | A vehicle performing the |
|---|---|---|
| | A conventional | leading current |
| | vehicle | determination control |
| A first port voltage THD | 1.77% | 2.02% |
| A first port current THD | 2.13% | 1.77% |
| A second port voltage THD | 1.47% | 1.62% |
| A second port current THD | 17.53% | 9.04% |
| The size of the current | 30A | 6A |
| distortion | | |

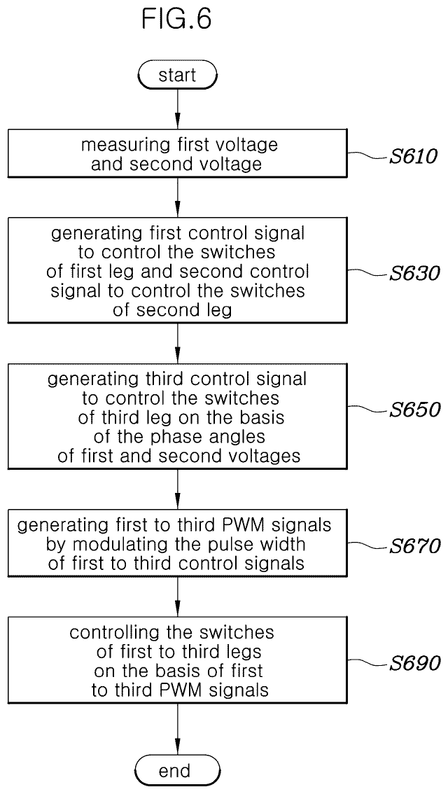

Referring to Table 1, it may be seen that the electric current of the second port of the vehicle to which the leading current determination control of embodiments of the present disclosure is applied may have a significantly improved current distortion compared to the electric current of the second port of the conventional vehicle. FIG. 6 shows a bidirectional OBC control method of an eco-friendly vehicle according to an exemplary embodiment of the present disclosure.

The bidirectional OBC control method of an eco-friendly vehicle according to the present exemplary embodiment may be performed by the bidirectional OBC control apparatus 100 of the eco-friendly vehicle in FIG. 1.

Referring to FIG. 6, the bidirectional OBC control apparatus 100 may measure a first voltage from a voltage sensor connected to an electronic device that is connected to the first line L1 among the three phase AC input lines L1, L2, and L3 and may measure a second voltage from the voltage sensor connected to an electronic device that is connected to the second line L2 among the three phase AC input lines L1, L2, and L3 (S610).

In addition, the bidirectional OBC control apparatus 100 may generate a first control signal to control switches of the first leg and a second control signal to control switches of the second leg (S630).

In this case, the bidirectional OBC control apparatus 100 may be provided with a three-phase bidirectional PFC, wherein a switch Q1 and a switch Q4 form a first leg, a switch Q2 and a switch Q5 form a second leg, a switch Q3 and a switch Q6 form a third leg, the first line L1 is connected to the first leg, the second line L2 is connected to the second leg, and the third line L3 different from the first line L1 and the second line L2 is connected to the third leg.

In addition, the bidirectional OBC control apparatus 100 may generate a third control signal to control the switches of the third leg on the basis of the phase angles of the first and second voltages (S650).

In addition, the bidirectional OBC control apparatus 100 may generate first to third PWM signals by modulating the pulse widths of the first to third control signals (S670).

In this case, the switches of the third leg may be controlled to be synchronized to the switches of the first leg or the second leg on the basis of the phase angles of the first and second voltages.

In this case, the switches of the third leg may be controlled to be synchronized to the switches of the first leg when the phase angle of the first voltage is faster than the phase angle of the second voltage.

In this case, the switches of the third leg may be controlled to be synchronized to the switches of the second leg when the phase angle of the second voltage is faster than the phase angle of the first voltage.

In addition, the bidirectional OBC control apparatus 100 may control the switches of the first to third legs on the basis of the first to third PWM signals (S690).

According to the exemplary embodiments of the present disclosure described so far, the current distortion caused by a phase difference of each phase may be minimized when using two different AC input ports of the bidirectional OBC.

In addition, the current distortion caused by the phase difference of the loads in a dual V2L operation may be minimized, so that a stable power source is served and the power stability is increased.

In addition, consumers may connect electrical devices to AC input ports without distinguishing between capacitive or inductive loads, thereby increasing convenience.

In addition, there is no need to add a separate additional element in order to reduce the current distortion caused by the phase difference of the load, thereby reducing costs.

Meanwhile, embodiments of the present disclosure described above may be implemented as computer-readable code on a medium on which a program is recorded. The computer-readable medium may include all types of recording devices in which data readable by a computer system is stored. Examples of a computer-readable medium may include hard disk drives (HDDs), solid state disks (SSDs), silicon disk drives (SDDs), ROM, RAM, CD-ROMS, magnetic tapes, floppy disks, optical data storage devices, and the like. Therefore, the above-detailed description should not be construed as restrictive in all respects and should be considered exemplary. The scope of the present disclosure should be determined by a reasonable interpretation of the accompanying claims, and all changes within the equivalent scope of the present disclosure are included in the scope of the present disclosure.

What is claimed is:

1. A control method for a bidirectional on-board charger (OBC), the method comprising:
measuring a first voltage of a first alternating current (AC) port connected to a first line among three-phase AC input lines and measuring a second voltage of a second AC port connected to a second line among the three-phase AC input lines; and
controlling a low-frequency leg among a plurality of legs in the bidirectional OBC to be synchronized to the first AC port or the second AC port based on phase angles of the first voltage and the second voltage.

2. The control method of claim 1, wherein:
the bidirectional OBC comprises a three-phase bidirectional power factor corrector;
a first switch and a fourth switch define a first leg, a second switch and a fifth switch define a second leg, and a third switch and a sixth switch define a third leg;
the first line is connected to the first leg, the second line is connected to the second leg, and a third line different from the first line and the second line is connected to the third leg; and
the low-frequency leg is the third leg.

3. The control method of claim 2, wherein the third switch and the sixth switch of the third leg are controlled to be synchronized to the first switch and the fourth switch of the first leg or the second switch and the fifth switch of the second leg based on the phase angles of the first voltage and the second voltage.

4. The control method of claim 3, wherein the third switch and the sixth switch of the third leg are controlled to be synchronized to the first switch and the fourth switch of the first leg in a case in which the phase angle of the first voltage is faster than the phase angle of the second voltage.

5. The control method of claim 3, wherein the third switch and the sixth switch of the third leg are controlled to be synchronized to the second switch and the fifth switch of the second leg in a case in which the phase angle of the second voltage is faster than the phase angle of the first voltage.

6. The control method of claim 2, further comprising generating a first control signal to control the first switch and the fourth switch of the first leg and a second control signal to control the second switch and the fifth switch of the second leg.

7. The control method of claim 6, further comprising generating a third control signal to control the third switch and the sixth switch of the third leg based on the phase angles of the first voltage and the second voltage.

8. The control method of claim 7, further comprising:
generating a first pulse width modulation (PWM) signal, a second PWM signal, and a third PWM signal by modulating pulse widths of the first control signal, the second control signal, and the third control signal; and
controlling the first switch and the fourth switch of the first leg, the second switch and the fifth switch of the second leg, and the third switch and the sixth switch of the third leg based on the first PWM signal, the second PWM signal, and the third PWM signal.

9. A control apparatus for a bidirectional on-board charger (OBC), the control apparatus comprising:
a sensor system configured to measure a first voltage by using a first voltage sensor connected to a first electronic device connected to a first line among three-phase alternating current (AC) input lines and configured to measure a second voltage by using a second voltage sensor connected to a second electronic device connected to a second line among the three-phase AC input lines; and
a controller configured to control a low-frequency leg among a plurality of legs in the bidirectional OBC to be synchronized to a first AC port or a second AC port based on phase angles of the first voltage and the second voltage.

10. The control apparatus of claim 9, wherein:
the bidirectional OBC comprises a three-phase bidirectional power factor corrector;
a first switch and a fourth switch define a first leg, a second switch and a fifth switch define a second leg, a third switch and a sixth switch define a third leg;
the first line is connected to the first leg, the second line is connected to the second leg, and a third line different from the first line and the second line is connected to the third leg; and
the low-frequency leg is the third leg.

11. The control apparatus of claim 10, wherein the controller is configured to control the third switch and the sixth switch of the third leg to be synchronized to the first switch and the fourth switch of the first leg or the second switch and the fifth switch of the second leg based on the phase angles of the first voltage and the second voltage.

12. The control apparatus of claim 11, wherein the controller is configured to control the third switch and the sixth switch of the third leg to be synchronized to the first switch and the fourth switch of the first leg in a case in which the phase angle of the first voltage is faster than the phase angle of the second voltage.

13. The control apparatus of claim 11, wherein the controller is configured to control the third switch and the sixth switch of the third leg to be synchronized to the second switch and the fifth switch of the second leg in a case in which the phase angle of the second voltage is faster than the phase angle of the first voltage.

14. A control apparatus for a bidirectional on-board charger (OBC) comprising a three-phase bidirectional power factor corrector, the control apparatus comprising:
a sensor system configured to measure a first voltage by using a first voltage sensor connected to a first electronic device connected to a first line among three-phase alternating current (AC) input lines and configured to measure a second voltage by using a second voltage sensor connected to a second electronic device connected to a second line among the three-phase AC input lines; and
a controller configured to:
control a low-frequency leg among a plurality of legs in the bidirectional OBC to be synchronized to a first AC port or a second AC port based on phase angles of the first voltage and the second voltage, wherein a first switch and a fourth switch define a first leg of the plurality of legs, a second switch and a fifth switch define a second leg of the plurality of legs, and a third switch and a sixth switch define a third leg of the plurality of legs, wherein the first line is connected to the first leg, the second line is connected to the second leg, and a third line different from the first line and the second line is connected to the third leg, and wherein the low-frequency leg is the third leg; and
generate a first control signal to control the first switch and the fourth switch of the first leg and a second control signal to control the second switch and the fifth switch of the second leg.

15. The control apparatus of claim 14, wherein the controller is configured to generate a third control signal to control the third switch and the sixth switch of the third leg based on the phase angles of the first voltage and the second voltage.

16. The control apparatus of claim 15, wherein the controller is configured to:
generate a first pulse width modulation (PWM) signal, a second PWM signal, and a third PWM signal by modulating pulse widths of the first control signal, the second control signal, and the third control signal; and
control first switch and the fourth switch of the first leg, the second switch and the fifth switch of the second leg, and the third switch and the sixth switch of the third leg based on the first PWM signal, the second PWM signal, and the third PWM signal.

17. The control apparatus of claim 14, wherein the controller is configured to control the third switch and the sixth switch of the third leg to be synchronized to the first switch and the fourth switch of the first leg or the second switch and the fifth switch of the second leg based on the phase angles of the first voltage and the second voltage.

18. The control apparatus of claim 17, wherein the controller is configured to control the third switch and the sixth switch of the third leg to be synchronized to the first switch and the fourth switch of the first leg in a case in which the phase angle of the first voltage is faster than the phase angle of the second voltage.

19. The control apparatus of claim 17, wherein the controller is configured to control the third switch and the sixth switch of the third leg to be synchronized to the second switch and the fifth switch of the second leg in a case in which the phase angle of the second voltage is faster than the phase angle of the first voltage.
